(19) United States
(12) Patent Application Publication
(10) Pub. No.: US 2004/0004332 A1
(43) Pub. Date: Jan. 8, 2004

(54) Caster receiving device for luggage

(76) Inventor: Bi-Hua Tsai, Taichung City (TW)

Correspondence Address: Hart, Baxley, Daniels & Holton, Fifth Floor, 59 John Street, New York, NY, 10038, US

(21) Appl. No.: 10/189,682

(22) Filed: Jul. 8, 2002

(51) Int. Cl. B62B 1/10

(52) U.S. Cl. 280/43.1; 280/47.315

(57) ABSTRACT

A luggage includes a bottom tube located at the underside of the luggage and two casters are retractably received in the two opening of the bottom tube. The two casters are connected to two links which are connected to two ends of a bar. The bar is supported on two springs and can be pressed to compress the spring by the retractable inner tube of the handle. The two casters are retracted in the bottom tube when the inner tube is located in retracted position, and the two casters pop out when the inner tube is pulled out.

### FIELD OF THE INVENTION

The present invention relates to a luggage which has two casters which are connected to the retractable handle and retractably connected to the bottom of the luggage so that when the handle is in retracted position, the casters are received in the bottom of the luggage.

### BACKGROUND OF THE INVENTION

A conventional luggage generally includes a box portion for receiving clothes or goods therein and two casters are connected to an underside of the box. A retractable handle is connected to the box so that the user may hold the handle and move the luggage conveniently. However, the casters protrude from the underside of the luggage so that when the luggage stands on the floor, it is in a tilt position because of the casters. In other words, the luggage tends to fall or slide when it is hit laterally.

The present invention intends to provide a luggage which has retractable casters so that the luggage stands by a flat underside when the handle is retractable.

### SUMMARY OF THE INVENTION

In accordance with one aspect of the present invention, there is provided a retractable caster device for luggage and the device comprises a bottom tube connected to an underside of the luggage and two casters are movably received in two openings of the bottom tube. Two springs are connected to an inside of the bottom tube and a bar is supported on the two springs. Two links are pivotably connected to the bottom tube and two ends of each link are respectively connected to an end of the bar and the two casters.

At least one outer tube is connected to the bottom tube and an inner tube is retractably received in the at least one outer tube. The inner tube contacts the bar.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the caster receiving device of the present invention;

FIG. 2 is a cross sectional view to show the inner tube contacts the bar which is supported on a spring;

FIG. 3 shows the casters are retracted upward in the bottom tube when the inner tube pushes the bar;

FIG. 4 shows the casters are lowered from the bottom tube when the inner tube is pulled away from the bar, and

FIG. 5 shows the luggage is put on the floor with its flat underside.

### DETAILED DESCRIPTION OF THE PREFERRED EMBODIMENT

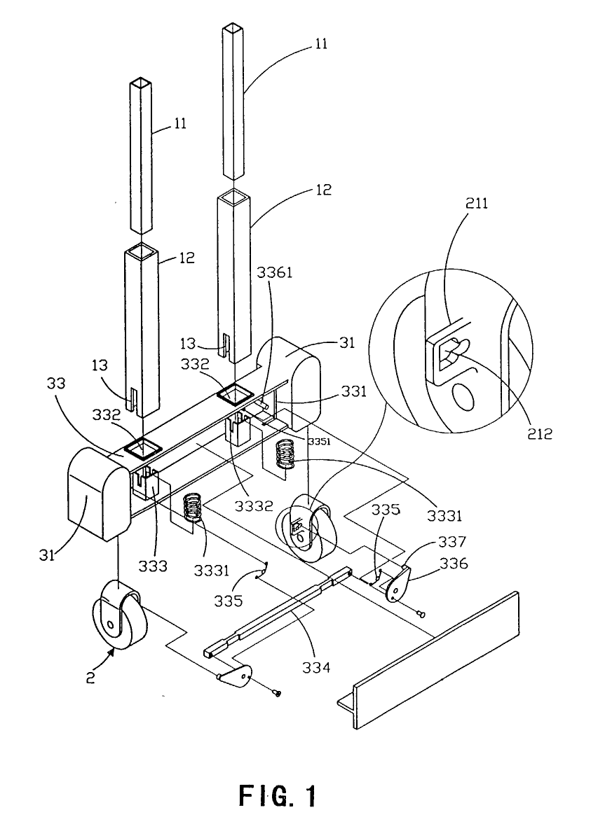

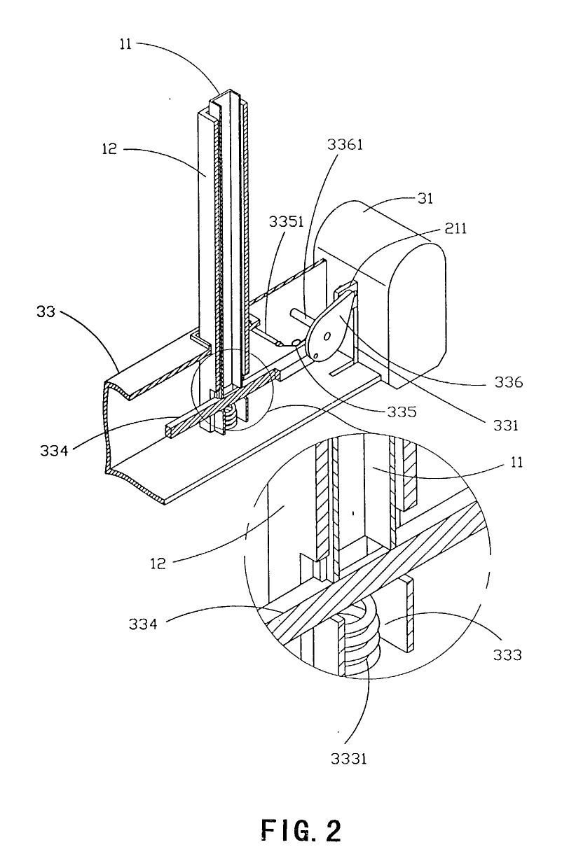

Referring to FIGS. 1 and 2, the caster receiving device for luggage of the present invention comprises a bottom tube 33 connected to an underside of the luggage and two receiving portions 31 are connected to two ends of the bottom tube 33. Each receiving portion 31 has an opening defined in an underside thereof so as to receive two casters 2 therein. Each receiving portion 31 has a slit 331 defined through a wall thereof and communicating with an interior of the bottom tube 33. Each caster 2 has a lug 211 and a hole 212 is defined through the lug 211. The two lugs 211 are movably inserted in the two slits 331.

Two retaining boxes 333 are located on the inside of the bottom tube 33 and each retaining box 333 has an open top for receiving a spring 3331 therein. Two first slots 3332 are defined in two opposite walls of each of the retaining boxes 333. A bar 334 is supported on the two springs 3331.

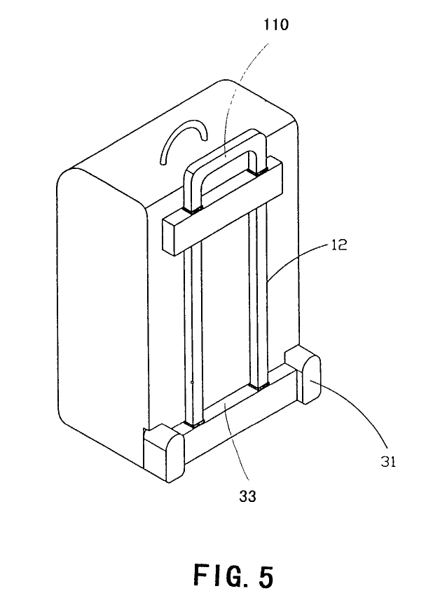

Two outer tubes 12 extend through two apertures 332 defined in a top of the bottom tube 33 and each outer tube 12 has two second slots 13 defined in an end thereof. The first slots 3332 and the second slots 13 communicate with each other. The bar 334 is movably engaged in the first slots 3332 and the second slots 13. Each outer tube 12 has an inner tube 11 retractably received therein and the inner tubes 11 contact the bar 334. A handle 110 is connected between the two inner tubes 11 as shown in FIG. 5.

Two links 336 are pivotably connected to two rods 3361 extending from the inside of the bottom tube 33 and each link 336 has a first end connected to respective one of two ends of the bar 334, and two respective second ends of the two links 336 are pivotably connected to the two casters 2. Each second end of the link 336 has a pin 337 which is movably engaged with the hole 212 of the lug 211. A torsion spring 335 is connected between each of the links 336 and the inside of the bottom tube 33.

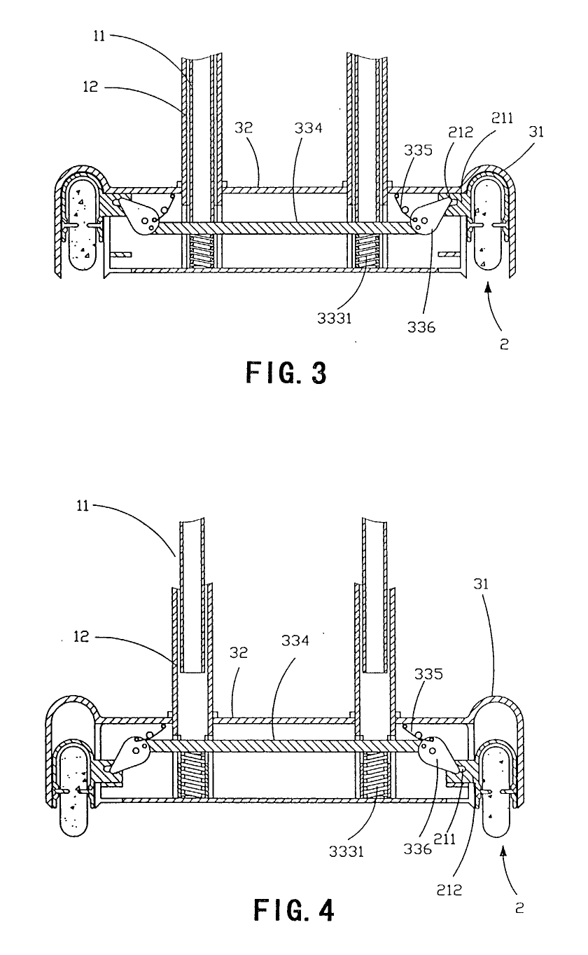

As shown in FIG. 3, when the inner tubes 11 are retracted in the outer tubes 12 and push the bar 334 to compress the springs 3331, the links 336 are pivoted about the axis of each of the rods 3361 and lift the lugs 211 upward to receive the casters 2 in the receiving portions 31. The torsion springs 335 help the links 336 to be maintained in the position.

Referring to FIG. 4, when the user pulls the inner tubes 11 out, the springs 3331 raise the bar 334 and the links 336 are pivoted to lower the casters 2.

As shown in FIG. 5, when the casters 2 are received in the receiving portions 31, the luggage has a flat underside which is put on the floor and the luggage is put in a stable status.

While we have shown and described the embodiment in accordance with the present invention, it should be clear to those skilled in the art that further embodiments may be made without departing from the scope of the present invention.

What is claimed is:

1. A retractable caster device for luggage comprising:
a bottom tube adapted to be connected to an underside of the luggage, two openings defined in an underside of the bottom tube and two casters movably received in the two openings, two springs connected to an inside of the bottom tube and a bar supported on the two springs, two links pivotably connected to the bottom tube and each link having a first end connected to respective one of two ends of the bar and two respective second ends of the two links pivotably connected to the two casters, and
at least one outer tube connected to the bottom tube and an inner tube retractably received in the at least one outer tube, the inner tube contacting the bar.

2. The device as claimed in claim 1, wherein each caster has a lug and a hole is defined through the lug, each second end of the link having a pin which is movably engaged with the hole of the lug.

3. The device as claimed in claim 1, wherein a torsion spring connected between each of the links and the inside of the bottom tube.

4. The device as claimed in claim 1 further comprising two retaining boxes on the inside of the bottom tube and each retaining box having an open top for receiving the spring therein, two first slots defined in two opposite walls of each of the retaining boxes, each outer tube having two second slots defined in an end thereof and the first slots and the second slots communicating with each other, the bar movably engaged in the first slots and the second slots.
